(19) United States
(12) Patent Application Publication
(10) Pub. No.: US 2009/0252173 A1
(43) Pub. Date: Oct. 8, 2009

(54) Method For Improving Efficiency Of Redundancy Protocols

(76) Inventors: Rangaprasad Sampath, Bangalore Karnataka (IN); Ashwin Bhalchandra Hegde, Roseville, CA (US); John R. Reilly, Roseville, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/196,264

(22) Filed: Aug. 21, 2008

(30) Foreign Application Priority Data
Apr. 3, 2008 (IN) 839/CHE/2008

(51) Int. Cl. H04L 12/56

(52) U.S. Cl. 370/400

(57) ABSTRACT

A method for improving efficiency of redundancy protocols used in a network is provided. The network comprises a first router running a program instance of a router redundancy protocol in a master state at a first interface and a dynamic protocol at a second interface, and a second router running another program instance of the router redundancy protocol in a backup state at a first interface and the dynamic protocol at a second interface. The program instance at the second router takes over the roles of the program instance at the first router during a failure of the first router. The method comprises establishing an online status of the first router, initiating a routing convergence process by the dynamic protocol at the first router, and taking over the roles from the program instance at the second router by the program instance at the first router when the routing convergence process has ended.

### CROSS-REFERENCE TO RELATED APPLICATION

This application claims priority to Indian Patent Application No. 839/CHE/2008, entitled “A METHOD FOR IMPROVING EFFICIENCY OF REDUNDANCY PROTOCOLS”, filed on Apr. 3, 2008, which is hereby incorporated by reference in its entirety.

### FIELD OF THE INVENTION

This invention relates generally to redundancy protocols, and in particular, to a method for improving efficiency of redundancy protocols to be used in conjunction with routing protocols.

### BACKGROUND OF THE INVENTION

Virtual Router Redundancy Protocol (VRRP) is an internet standard described in RFC 3768 for providing router redundancy in a network. The VRRP introduces the concept of a virtual router in a network. The virtual router is associated with an IP address, and comprises two or more physical routers, known as VRRP routers. The VRRP specifies an election protocol that dynamically assigns the routing responsibility of the virtual router to one of the VRRP routers in the network. The VRRP router with the routing responsibility is called the Master, and forwards packets sent to the IP address associated with the virtual router.

When the Master becomes unavailable, one of the other VRRP routers will assume the routing responsibility of the virtual router and forwards packets sent to the IP address of the virtual router. This is known as the VRRP failover. Therefore, the VRRP ensures continuity of service in event of failures by providing redundancy for critical routers in the network. The VRRP is commonly used in providing redundancy for gateways at end-points of networks.

When the Master becomes available again, it takes over the routing responsibility of the virtual router from the other VRRP router immediately. This is known as the VRRP failback. However, the immediate take-over by the Master causes a problem when a dynamic protocol is also enabled on the Master VRRP router. This is because the VRRP failback occurs in about 1-2 seconds, but a dynamic protocol such as Open Shortest Path First (OSPF) takes a much longer time to converge. The routing table in the Master only gets updated after the dynamic protocol at the Master has converged. Therefore immediately after VRRP failback has occurred, routing table in the Master will not be updated yet and the Master will not be able to forward any packets sent to it. As a result, these packets sent to the Master after VRRP failback but before the dynamic protocol has converged are dropped by the Master VRRP router and hence lost to the network.

An attempt to overcome this problem is to delay the occurrence of the VRRP failback by a predefined time interval when the Master becomes available. In other words, when the Master becomes available, it will only take over the routing responsibility of the virtual router from the other VRRP router after the expiry of the predefined time interval. However, a delayed VRRP failback does not ensure that the dynamic protocol has converged. Furthermore, it is very difficult to determine the convergence time of the dynamic protocol as it is dependent on many factors including network size, the dynamic protocol used, etc.

### SUMMARY OF THE INVENTION

According to an embodiment, a method for improving efficiency of redundancy protocols used in a network is provided. The network comprises a first router running a program instance of a router redundancy protocol in a master state at a first interface and a dynamic protocol at a second interface, and a second router running another program instance of the router redundancy protocol in a backup state at a first interface and the dynamic protocol at a second interface. The program instance at the second router takes over the roles of the program instance at the first router during a failure of the first router. The method comprises establishing an online status of the first router, initiating a routing convergence process by the dynamic protocol at the first router, and taking over the roles from the program instance at the second router by the program instance at the first router when the routing convergence process has ended.

### BRIEF DESCRIPTION OF THE DRAWINGS

The embodiments of the invention will be better understood in view of the following drawings and the detailed description.

FIG. 1 shows an example of a network implementing VRRP on a pair of routers as a gateway for a host according to one embodiment.

FIG. 2 shows a flow-chart of a method of VRRP failback according to an embodiment.

FIG. 3 shows a flow-chart of the method of VRRP failback according to another embodiment.

### DETAILED DESCRIPTION OF THE INVENTION

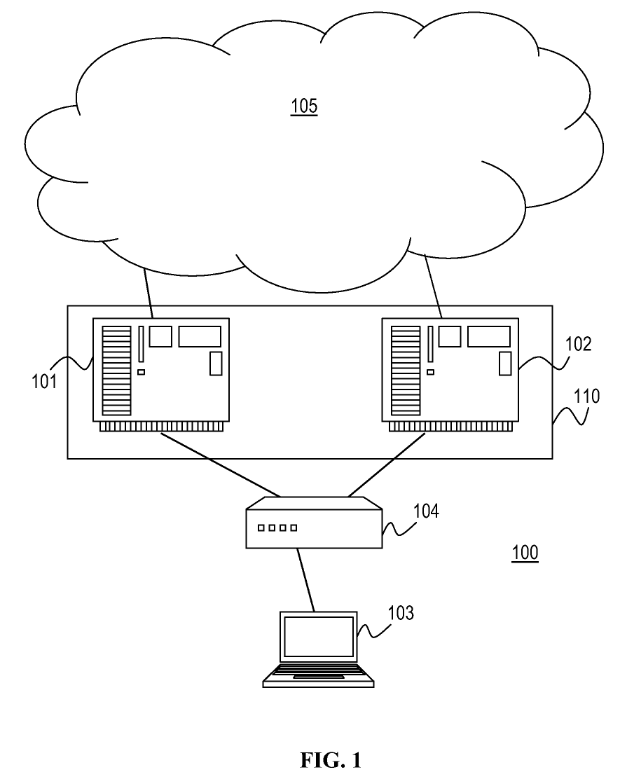

FIG. 1 shows an example of a network 100 implementing a Virtual Router Redundancy Protocol (VRRP) on a pair of routers 101, 102 in an embodiment. The network 100 includes a host 103, a switch 104, a pair of VRRP routers 101, 102, and other portions of the network 100 represented by a network cloud 105. The host 103 includes a notebook, personal computer (PC) or any computing device which a user may use to access the network 100.

The host 103 accesses the network 100 via a gateway, which is implemented using a virtual router 110. The virtual router 110 is an abstract router object managed by the VRRP, and includes two or more routers running VRRP, known as VRRP routers. In this example, the virtual router 110 includes the two VRRP routers 101, 102. Each VRRP router 101, 102 has at least one interface running an VRRP instance. An VRRP instance is a VRRP program implementing VRRP on the router.

One of the VRRP routers 101, 102 of the virtual router 110 is designated as the Owner or Master. The VRRP router 101, 102 designated as the Master functions in a master state, and performs the routing function for the virtual router 110. In this example, the VRRP router 101 is designated as the Master. The Master 101 is associated with an IP address of the virtual router 110. Accordingly, any packets sent to the IP address of the virtual router 110 are sent to the Master 101, and the Master 101 assumes the responsibilities of forwarding these packets and answering ARP requests for this IP address. When the IP address of the virtual router is configured as a real IP address on the interface of the Master 101 running the VRRP instance, the Master 101 is also known as the IP Address Owner.

The other VRRP router 102 is known as a Backup and functions in a backup state. When the Master 101 loses connectivity to the network, for example due to device failure or taken down for maintenance, the Master 101 “fails over” to the Backup 102. In other words, the Backup 102 transitions to the master state, takes over the IP address of the virtual router 110, and assumes the responsibilities of forwarding packets and answering ARP requests for this IP address. When the Backup 102 has transitioned to the master state, it has become the owner of the virtual router 110. In this manner, the Backup 102 provides redundancy to the Master 101, and the reliability of the gateway service for the host 103 is ensured.

The switch 104 forwards packets from the host 103 to the Master 101 and from the Master 101 to the host 103. During a failover where the Backup 102 takes over the IP address of the virtual router 110, the switch 104 forwards packets from the host 103 to the Backup 102 and from the Backup 102 to the host 103. The network cloud 105 represents other portions of the network 100, which may include but not limited to routers, gateways and the Internet.

It should be noted that the network 100 shown in FIG. 1 is only an example, and the invention is not limited to the configuration and implementation shown in FIG. 1. It is possible to implement the VRRP according to the embodiment in different configurations of networks. For example, several hosts 103 may be connected to the switch 104, the virtual router 110 may include more than two VRRP routers, the VRRP may be used to provide redundancies for other routers other than for the gateway for the host 103, and other configurations known to a person ordinary skilled in the art.

The VRRP routers 101, 102 may also provide backup for more than one virtual routers. For example, the VRRP router 101, while functioning in the master state for the virtual router 110, may also function in a backup state for another virtual router (not shown). Similarly, the VRRP router 102, while functioning in the backup state for the virtual router 110, may also function in the master state for the other virtual router.

In one embodiment, each VRRP router 101, 102 has a first interface running a VRRP instance and a second interface running a dynamic protocol. In a further embodiment, the first interface running the VRRP instance provides gateway service to the host 103, and the second interface running the dynamic protocol provides routing service for the network 100.

The operation of the VRRP shall be described herein briefly with reference to the network 100 as shown in FIG. 1. During the operation of the VRRP, the VRRP instance in the Master 101 sends multicast packets to the other VRRP instance in the Backup 102 (or if there are more than one backup VRRP routers, to all other VRRP instances in the other backup VRRP routers). The multicast packets from the Master 101 inform that it is the Owner for the virtual router 110. The VRRP instance in the Backup 102 listens for the multicast packets from the Master 101.

If the Master 101 fails and loses connectivity to the network 100, the Backup 102 does not receive any multicast packets from the Master 101. After a preconfigured time interval of not receiving any multicast packets from the Master 101, the VRRP instance at the Backup 102 assumes that the Master 101 has failed, and proceeds to transition to the master state for the virtual router 110. This is known as a VRRP failover. After the failover, the Backup 102 starts sending its own multicast packets to inform that it is now the owner of the virtual router 110. When there are more than one backup VRRP routers, the VRRP instance having the highest priority (excluding the VRRP instance in the Master 101) will be elected to become the owner of the virtual router 110.

When the Master 101 restores its connectivity to the network 100, it takes over the responsibilities for packets forwarding and answering ARP requests from the Backup 102 (by transitioning to the master state). This is known as VRRP failback. At the same time, due to the re-establishment of the connectivity of the Master 101 in the network 100, the dynamic protocol running at the second interface of the Master 101 also initiates a convergence process which includes updating of routing tables of the Master 101. According to an embodiment, the Master 101 does not transition to the master state immediately, but rather waits until the convergence process of the dynamic protocol at its second interface has ended. In other words, the VRRP instance running on the Master 101 only transitions to the master state after the dynamic protocol running on the second interface of the Master 101 has converged.

The dynamic protocol includes, but is not limited to, the Open Shortest Path First (OSPF) and the Routing Information Protocol (RIP). Both the protocols of OSPF and RIP are well-known to a person skilled in the art, and hence, only a brief description of the protocols will be described.

OSPF is a link-state protocol which works by sending link-state advertisements (LSA) to other routers in a network to obtain local link-state information of each router. All link-state information received from the other routers is used to form a topology or link-state database which gives an overall picture of the status of the links in the network. Based on this topology database, each OSPF instance running on each router calculates a shortest path to each destination in the network. Once the shortest path to each destination has been calculated, a routing table in each router is constructed/updated for forwarding packets. When there are changes to the network topology, the topology database is reconstructed, and the shortest path to each destination is re-calculated.

The construction of the topology database and the calculation of the shortest paths to destinations is also known as the routing convergence process of the OSPF. When a router running the OSPF is powered up, it starts establishing adjacencies with its neighbors or neighboring routers. The adjacency establishment includes exchanging link-state packets such as database description packets to exchange information on the topology database between the routers. Once the topology databases between the routers are synchronized, the routers are said to be adjacent. The routers then calculate the shortest path to each destination. After this stage, it can be said that the OSPF running on the routers has converged.

With reference to the example in FIG. 1, when the Master 101 is powered up and re-establishes connectivity to the network 100 after a failover, the OSPF instance running on the second interface starts establishing adjacencies with other routers in the network 100. The VRRP instance at the Master 101 goes into an initialization state. The VRRP instance may be configured to function in a master or backup state upon startup. If the VRRP instance is configured to function in the backup state, it will transition to the backup state and listens for multicast packets from the Owner. However when the VRRP instance is configured to function in the master state, it will transition to an initialize/waiting state according to an embodiment.

Once the OSPF instance running on the second interface has synchronized its topology database with the topology databases with the other routers in the network 100, it proceeds to calculate the shortest path to each destination in the network 100. Upon completion of this stage, the OSPF instance informs the VRRP instance running on the Master 101 that the convergence process has ended. According to the embodiment, the VRRP instance at the initialize/waiting state, upon being informed that the convergence process has ended, transitions to the master state and declares itself as the owner of the virtual router 110 by sending out multicast packets. The Backup 102 upon receiving the multicast packets from the Master 101 transitions back to the backup state.

RIP uses a distance vector algorithm to determine the routing table for forwarding packets. Routers running the RIP send a copy of their routing table to neighboring routers periodically. Each of the neighboring routers adds a hop count to the routing table and passes the updated routing table to another direct neighboring router. In this way, a new routing table based on hop count is generated, and can be used for forwarding packets.

A RIP router that comes back online sends out a multicast packet to all its neighbors requesting them to send the contents of their entire routing table. Based on the received responses, the RIP router computes its own distance vector i.e. a map of distances to all the destinations and updates its own routing table. At this point, a RIP router may start a timer of say Y seconds. If an update received within Y seconds leads to the change of the distance vector and therefore the routing table of the RIP router, the timer of Y seconds is refreshed. If the timer expires, which means that the distance vector and therefore the routing table of the RIP router do not change in Y seconds, RIP may conclude that the routing convergence process has ended.

With reference to the example in FIG. 1, when the Master 101 is powered up and re-establishes connectivity to the network 100 after a failover, the RIP running on the second interface sends a multicast packet to other routers in the network 100 requesting them to send the contents of their entire routing table, and starts a timer of Y seconds. If the VRRP instance is configured to function in the backup state, it will transition to the backup state and listens for multicast packets from the Owner. However when the VRRP instance is configured to function in the master state, it will transition to an initialize/waiting state according to an embodiment.

Once RIP does not receive any updates that change its distance vector and therefore the routing table in Y seconds, the timer of Y seconds expires. RIP detects the expiry of the timer of Y seconds and thus concludes routing convergence. RIP now informs the VRRP instance accordingly. According to the embodiment, the VRRP instance at the initialize/waiting state, upon being informed that the routing convergence process has ended, transitions to the master state and declares itself as the owner of the virtual router 110 by sending out multicast packets. The Backup 102 upon receiving the multicast packets from the Master 101 transitions back to the backup state.

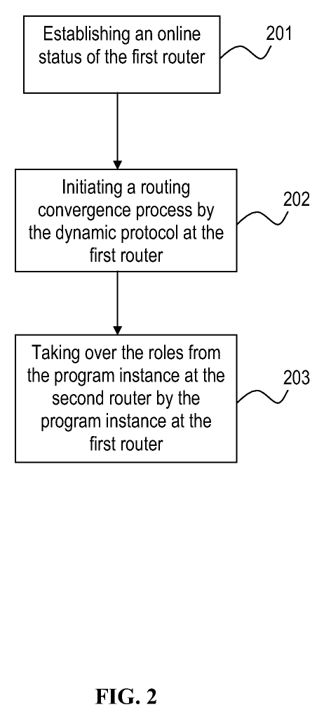

FIG. 2 shows a flow-chart of a method for improving efficiency of redundancy protocols according to an embodiment. The steps of the method will be described with reference to the virtual router 110 as shown in FIG. 1. In the normal operation of the virtual router 110, the VRRP instance at the Master 101 is in the master state and performs the roles of forwarding packets sent to the virtual router 110, and addressing ARP requests. The VRRP instance at the Backup 102 is in the backup state, listening for the multicast packets from the Master 101, and waiting to take over the roles from the Master 101 in the event that the Master 101 goes offline. As mentioned earlier, the Master 101 may go offline or loses connectivity to the network when taken down for maintenance or when it fails or malfunctions for some reasons. When the Master 101 goes offline, the VRRP instance at the Master 101 fails over to the VRRP instance at the Backup 102. In particular, the VRRP instance at the Backup 102 transitions to the master state.

Step 201 includes establishing an online status of the Master 101. When the failure in the Master 101 has been rectified or the Master 101 has been put back to the network after maintenance, its physical links will be re-established, and this brings up the interfaces of the Master 101. Such information is then conveyed to the dynamic protocol instance running on the interfaces of the Master 101 (for example, OSPF or RIP instance running on the second interface and/or VRRP instance running on the first interface). The online status of the Master 101 may then be established when the dynamic protocol instance starts sending out packets.

Step 202 includes initiating a routing convergence process by the dynamic protocol. When the Master 101 has resumed its connectivity to the network 100, the dynamic protocol running on the second interface of the Master 101 begins the convergence process. If the dynamic protocol running on the second interface is OSPF, it starts establishing adjacencies with the other routers in the network 100. If the dynamic protocol running on the second interface is RIP, it starts sending out multicast packets to all its neighbors requesting them to send the contents of their entire routing table.

Step 203 includes taking over the roles from the VRRP instance at the Backup 102 by the VRRP instance at the Master 101 when the routing convergence process has ended. After the VRRP failover, the VRRP instance at the Backup 102 is performing the roles of forwarding packets and addressing ARP requests. When the routing convergence process has ended, the Master 101 takes over the roles of forwarding packets and addressing ARP requests from the VRRP instance at the Backup 102. In particular, the Master 101 transitions to the master state, and the Backup 102 transitions to the backup state.

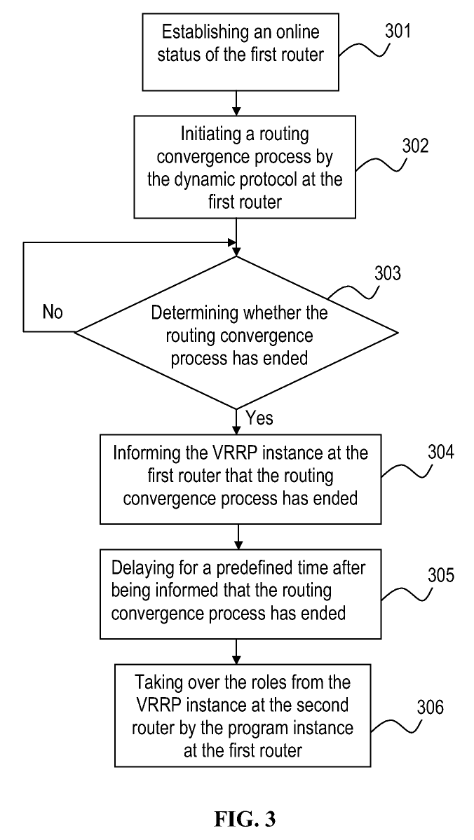

FIG. 3 shows a flow-chart of the method for improving efficiency of redundancy protocols according to another embodiment. The method for improving efficiency of redundancy protocols as shown in FIG. 3 shall be described with reference to the network 100 in FIG. 1 using the example of VRRP and OSPF. Step 301 includes establishing an online status of the Master 101. This step is similar to Step 201 in FIG. 2 where the Master 101 resumes its connectivity to the network 100.

Step 302 includes initiating a routing convergence process by the dynamic protocol. When the Master 101 resumes its connectivity to the network 100, the OSPF running on the second interface of the Master 101 begins the convergence process by establishing adjacencies with the neighboring routers in the network 100. As already mentioned earlier, the Master 101 exchanges link-state packets such as database description packets to exchange information on the topology database with the neighboring routers. When the topology or link-state databases of the Mater 101 and the neighboring routers are synchronized, these routers are said to be adjacent. At this stage, the Master 101 has enough information to run the Shortest Path First (SPF) algorithm and calculates the shortest path to each destination in the network 100.

Step 303 includes determining whether the routing convergence process of the dynamic protocol running at the second interface of the Master 101 has ended. The end of the routing convergence process for OSPF may be when the adjacencies of the Master 101 have been established, or when the shortest path to each destination in the network 100 has been calculated. When the adjacencies of the Master 101 have been established, the interface state of the Master 101 running the OSPF goes to “FULL”. Thus the “FULL” status of the interface state can be used to indicate that the adjacencies establishment is complete, and hence, the routing convergence process has ended. After the adjacencies establishment has been completed, the OSPF running on the second interface may further proceed to calculate the shortest path to each destination in the network 100. The OSPF at the second interface may only conclude that the convergence process has ended when the shortest path computation to each destination has been completed.

Step 304 includes informing the VRRP instance at the Master 101 that the routing convergence process has ended. The OSPF running on the second interface of the Master 101 informs the VRRP instance running on the first interface of the end of the routing convergence process indicated by the occurrence of certain events. In an example, after the adjacencies of the Master 101 have been established and the SPF calculation has been completed, the routing table in the Master 101 is updated with the calculated shortest path routes. When the routing table in the Master 101 has been updated, the OSPF informs the VRRP instance that the convergence process has ended.

In another example, after the adjacencies of the Master 101 have been established, OSPF starts a timer of a predefined time, say X seconds. When OSPF receives a link-state update packet or the routing table gets updated by OSPF before the expiry of X seconds, the timer is refreshed. If the timer expires without being refreshed (that is, no link-state update packets are received or updates to the routing table are done within X seconds), OSPF concludes the routing convergence process and informs the VRRP instance accordingly.

The OSPF running on the second interface of the Master 101 informs the VRRP instance of the end of the routing convergence process using a VRRP function call. The VRRP function handles the event resulting from the function call and the VRRP instance then proceeds to transition to the master state by taking over the IP Address of the virtual router 110. This function call may be an API (Application Program Interface) exposed by VRRP that is used by OSPF to notify routing convergence. It should be noted that a function call is only one method of notification from OSPF to VRRP. It is also possible for OSPF to notify or inform VRRP using other methods. An example of another method of informing or notifying the VRRP of the end of the routing convergence process includes an inter-process communication (IPC) method such as a message posted from OSPF to VRRP.

Step 305 includes delaying for a predefined time after being informed that the routing convergence process has ended. In other words, this step delays taking over the roles from the VRRP instance at the Backup 102 by the VRRP instance at the Master 101 for a predefined time period after being informed that the routing convergence process has ended. The delay is to ensure that the updating of the routing table in the Master 101 is complete before transitioning to the master state to take over the roles from the VRRP instance of the Backup 102. The defining of the time period for the delay is up to the discretion of a network administrator, and is also dependent on the size of the network. For example, if the network has less than 100 routers, the predefined period may be about 1 second. For a network having about 1000 routers, the predefined period may be about 10 seconds. It should be noted that Step 305 is optional in this embodiment and may be omitted. Also if the OSPF informs the VRRP instance of the Master 101 of the end of the convergence process only after the shortest paths are updated to the routing table, this Step 305 is not needed.

Step 306 includes taking over the roles from the VRRP instance at the Backup 102 by the VRRP instance at the Master 101 when the routing convergence process has ended. This is similar to Step 203 of FIG. 2 described earlier. Specifically, the Master 101 transitions to the master state after being informed by the OSPF instance that the routing convergence process has ended or after the time delay in Step 305 has elapsed, if applicable. At this state, the VRRP instance at the Master 101 resumes the forwarding of packets and answering ARP requests addressed to the virtual router 110. Accordingly, the process of VRRP failback is completed.

It should be noted that although the flow-chart of the method according to the embodiment shown in FIG. 3 was described with reference to the OSPF as the dynamic protocol running on the Master 101, the embodiment shown in FIG. 3 is not limited to using OSPF as the dynamic protocol. Other types of dynamic protocols may be used in this embodiment. An example of another dynamic protocol which may be used in this embodiment includes RIP.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed:

1. A method for improving efficiency of redundancy protocols used in a network, the network comprises a first router running a program instance of a router redundancy protocol in a master state at a first interface and a dynamic protocol at a second interface, and a second router running another program instance of the router redundancy protocol in a backup state at a first interface and the dynamic protocol at a second interface, wherein the program instance at the second router takes over the roles of the program instance at the first router during a failure of the first router, the method comprising:
establishing an online status of the first router;
initiating a routing convergence process by the dynamic protocol at the first router; and
taking over the roles from the program instance at the second router by the program instance at the first router when the routing convergence process has ended.

2. The method of claim 1, further comprising:
determining an end of the routing convergence process; and
informing the program instance at the first router when the routing convergence process has ended, wherein the program instance at the first router takes over the roles from the program instance at the second router thereafter.

3. The method of claim 2, further comprising:
delaying the taking over of the roles from the program instance at the second router by the program instance at the first router for a predefined period of time after being informed that the routing convergence process has ended.

4. The method of claim 1, wherein the router redundancy protocol comprises the Virtual Router Redundancy Protocol (VRRP).

5. The method of claim 1, wherein dynamic protocol comprises the Open Shortest Path Protocol (OSPF).

6. The method of claim 1, wherein the dynamic protocol comprises the Routing Information Protocol (RIP).

7. The method of claim 2, wherein determining an end of the routing convergence process comprises:
determining completion of adjacency establishment by the dynamic protocol at the second interface of the first router with neighboring routers in the network.

8. The method of claim 7, further comprising:
determining the shortest routes to all destinations in the network; and
updating the determined shortest routes to a routing table of the first router.

9. The method of claim 2, wherein determining an end of the routing convergence process comprises:
determining that no updates which changes a distance vector of the first router are received by the dynamic protocol at the second interface of the first router from other routers in the network for a predefined period of time.

10. The method of claim 2, wherein informing the program instance at the first router when the routing convergence process has ended comprises:
making a function call by the dynamic protocol at the second interface of the first router to the program instance at the first interface of the first router.

11. A virtual router object implementing a router redundancy protocol comprising:
a first router running a program instance of the router redundancy protocol in a master state at a first interface and a dynamic protocol at a second interface; and
a second router running another program instance of the router redundancy protocol in a backup state at a first interface and the dynamic protocol at a second interface,
wherein when the roles of the program instance at the first router has failed over to the program instance at the second router in the event of a failure of the first router and when the first router has now re-established its online status, the first router is adapted to:
initiate a routing convergence process by the dynamic protocol at the first router; and
take over the roles by the program instance at the first router from the program instance at the second router when the routing convergence process has ended.

12. The virtual router of claim 11, wherein the dynamic protocol at the first router is further adapted to:
determine an end of the routing convergence process; and
inform the program instance at the first router when the routing convergence process has ended, wherein the program instance at the first router takes over the roles from the program instance at the second router thereafter.

13. The virtual router of claim 12, wherein the program instance at the first router is further adapted to:
delay the taking over of the roles from the program instance at the second router by the program instance at the first router for a predefined period of time after being informed that the routing convergence process has ended.

14. The virtual router of claim 11, wherein the router redundancy protocol comprises the Virtual Router Redundancy Protocol (VRRP).

15. The virtual router of claim 11, wherein the dynamic protocol comprises the Open Shortest Path Protocol (OSPF).

16. The virtual router of claim 11, wherein the dynamic protocol comprises the Routing Information Protocol (RIP).

17. The virtual router of claim 12, wherein the dynamic protocol at the first router is adapted to determine the end of the routing convergence process by:
determining completion of adjacency establishment by the dynamic protocol at the second interface of the first router with neighboring routers in the network.

18. The virtual router of claim 17, wherein the dynamic protocol at the first router is further adapted to:
determine shortest routes to all destinations in the network; and
update the shortest routes to a routing table of the first router.

19. The virtual router of claim 12, wherein the dynamic protocol at the first router is adapted to determine the end of the routing convergence process by:
determining that no updates which changes a distance vector of the first router are received by the dynamic protocol at the second interface of the first router from other routers in the network for a predefined period of time.

20. The virtual router of claim 12, wherein the dynamic protocol at the first router is adapted to make a function call to the program instance at the first router to inform the program instance that the routing convergence process has ended.
